(19) United States
(12) Patent Application Publication
(10) Pub. No.: US 2006/0145783 A1
(43) Pub. Date: Jul. 6, 2006

(54) Method and apparatus for controlling power division in a travelling-wave antenna

(75) Inventor: Pentti Karhunen, Vantaa (FI)

Correspondence Address: BIRCH STEWART KOLASCH & BIRCH, PO BOX 747, FALLS CHURCH, VA, 22040-0747, US

(73) Assignee: Vaisala Oyj, Heisinki (FI)

(21) Appl. No.: 10/542,856

(22) PCT Filed: Feb. 13, 2004
(86) PCT No.: PCT/FI04/00069

§ 371 Date: Dec. 29, 2005

(30) Foreign Application Priority Data
Feb. 14, 2003 (FI) 20030234

(51) Int. Cl. H01P 5/12

(52) U.S. Cl. 333/136

(57) ABSTRACT

This publication discloses a method and apparatus for feeding signal power to an antenna array comprising several antenna elements (1-4). According to the method, the signal power is fed to the antenna elements (1-4) over two transmission lines (a-b) and (c-d), in which case the divisions (e) of one of the transmission lines (a-b) are shorter than the nominal wavelength and those (f) of the other (c-d) are longer than the nominal wavelength by the same amount, the signal s being fed is divided into two parts, one of which is led to one of the said two transmission lines (a) and the other to the opposite end (d) of the other line, in which case the signals travel in the lines in opposite directions, and the signals are summed (5) before the antenna elements (1-5).

The present invention relates to a method, according to the preamble of claim 1, for controlling power division in a travelling-wave antenna.

The invention also relates to an apparatus for controlling power division in a travelling-wave antenna.

The invention is intended to permit a desired form of amplitude distribution when feeding the transmission line of a travelling-wave antenna alternately from each end, in order to turn the lobe of the antenna to two different positions.

### THE PRIOR ART AND ITS DRAWBACKS

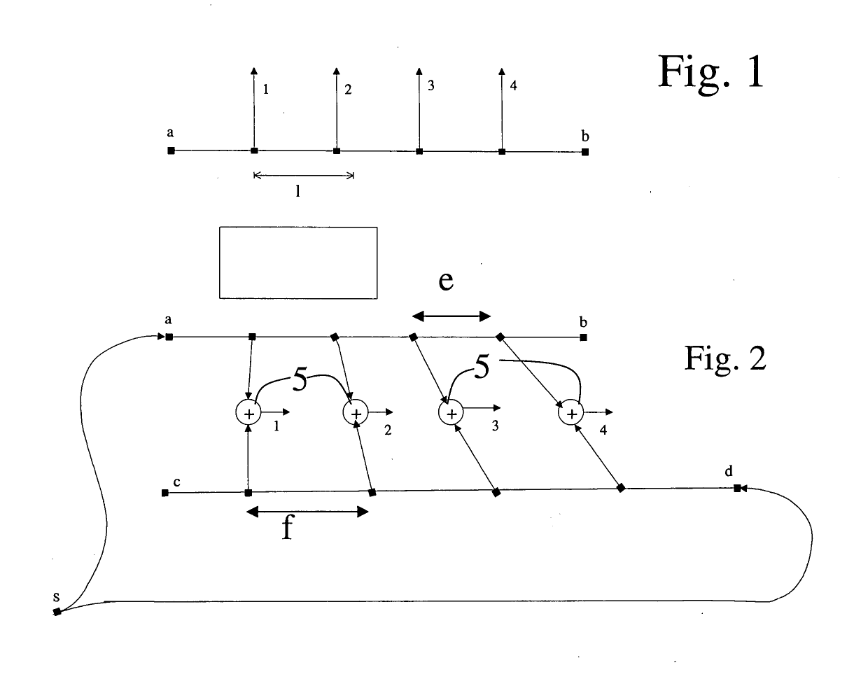

In a travelling-wave antenna, power is distributed to the radiating antenna elements along a serial line (FIG. 1), in which the phase of the signal going to the antenna elements (1, 2, 3, and 4) from one end (a) depends on the lengths of the parts of the transmission line and the amplitude on the division ratios of the connection points. If the transmission-line parts are of a length that is exactly the wavelength, the phase difference between the antenna elements will be zero, and the lobe of the antenna will be aligned perpendicular to the plane of the antenna elements.

If the length of the parts of the transmission line differs from the wavelength, there will be an equal phase difference between all the antenna elements, and the lobe of the antenna will turn away from the perpendicular position. If the transmission line is fed from the other end (b), the said phase difference will have the opposite sign, and the lobe will turn to the other side of the perpendicular position. Thus, the lobe of the antenna array can be turned to two positions, by using a suitable switch to change the direction of travel of the signal.

If the transmission line is fed from only one end a, the division ratios of the line can be dimensioned to give the antenna elements the desired amplitude distribution. If a transmission line designed in this way is fed from the other end b, the division ratios will no longer be the previous ones, while the characteristics of the lobe created will not be those desired. If the division ratios are to remain identical when the line is fed from both ends, a constant division ratio must be applied in the divisions of all the antenna elements, 1, 2, 3, and 4, which will result in the exponential diminution of the amplitude distribution. The side-lobe level of the antenna array will then increase.

The invention is intended to eliminate the defects of the state of the art disclosed above and for this purpose create an entirely new type of method and apparatus for controlling the power division of a travelling-wave antenna. By means of the solution according to the invention, the lobe of a travelling-wave antenna can be turned to two directions using a transmission line fed from different ends, so that the drawbacks described above are mostly avoided.

The invention is based on using two parallel transmission lines, the divisions of one of which being shorter than the nominal wavelength and those of the other being longer than the nominal wavelength by the same amount, dividing the signal s being fed into two parts, one of which is directed to one of the two said transmission lines a and the other is directed to the opposite end d of the other line, so that the signals travel in opposite directions in the lines. In that case, the signals will be in the same phase at the corresponding divisions in the transmission lines. The same-phase signals diverging from points corresponding to the position of the divisions of the transmission lines are summed and directed to the antenna elements 1, 2, 3, and 4.

More specifically, the method according to the invention is characterized by what is stated in the characterizing portion of claim 1.

The apparatus according to the invention is, in turn, characterized by what is stated in the characterizing portion of claim 3.

Considerable advantages are gained with the aid of the invention.

The amplitude distribution is identical in both positions of the antenna lobe.

Altering the division ratio allows the amplitude distribution to be optimized, in order to achieve the desired characteristics of the lobe.

In the following, the invention is examined with the aid of examples and with reference to the accompanying drawings.

FIG. 1 shows a schematic diagram of the feed line of a travelling-wave antenna according to the prior art.

FIG. 2 shows a schematic diagram of a dual-travel-wave feed line according to the invention.

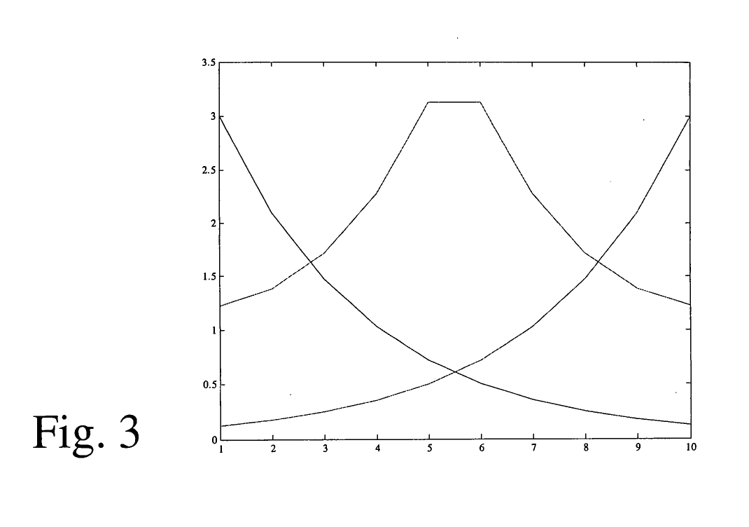

FIG. 3 shows graphically the amplitude distribution of the transmission lines, when using a constant division.

Thus, in the solution according to the invention, operation is as follows:

1.) In the solution, two parallel transmission lines are used, the divisions e of one being shorter than the nominal wavelength and the divisions f of the other being longer by the same amount than the nominal wavelength (FIG. 2). Thus, when the signal travels in the lines, in the same direction, the phase-differences arising in the divisions will be opposite.

The power-division ratios of the transmission lines are typically at least approximately identical.

2.) The signal s being fed is divided into two parts, one of which is directed to the end a of the transmission line a-b and the other to the opposite end d of the other line c-d, so that the signals travel in opposite directions in the lines. In that case, the signals will be in the same phase at the corresponding divisions.

3.) The same-phase signals diverging from the corresponding points at the locations of the divisions of the transmission lines are summed in a summing unit 5 and directed to the antenna elements 1, 2, 3, and 4. Thus, when using constant power-division ratios, the amplitude distribution of both lines will be identically exponentially diminishing (FIG. 3). Due to the summing that takes place in the summing amplifier 5 preceding the antenna elements 1, 2, 3, and 4, the final amplitude distribution is symmetrical. If it is wished to reduce the side-lobe level of the antenna array, the signals from the divisions 1, 4 at the ends of the transmission line are directed to the centre of the antenna array and from the divisions 2, 3 in the centre to the outer ends of the array (FIG. 3), as the amplitude of the signal is greatest at the divisions at the ends. The final amplitude distribution can be controlled by altering the division ratio of the divisions.

4.) If it is wished to alter the direction of the lobe, the transmission lines are altered to feed from the point b and c, in which case the signals will travel in a different direction, though the mutual phase-differences will remain the same at the points 1, 2, 3, and 4. In practice, this change in feed takes place with the aid of a switch, which is not shown. Because the amplitude distribution is symmetrical, it will remain identical in both positions of the antenna lobe, when the direction of travel of the signal is altered. If it is wished to reduce the side-lobe level of the antenna array, the signals from the divisions 1, 4 at the ends of the transmission line are directed to the centre of the antenna array and from the divisions in the centre to the outer ends of the array, because the amplitude of the signal is greatest at the divisions at the ends. The final amplitude division can be controlled by altering the ratio of the divisions.

1. A method for feeding signal power to an antenna array comprising several antenna elements (1-4), which method is characterized in that
two parallel transmission lines (a-b) and (c-d) are used, in which case the divisions (e) of one (a-b) of the transmission lines are shorter than the nominal wavelength and those (f) of the other (c-d) are longer than the nominal wavelength by the same amount,
the signal s being fed is divided into two parts, one of which is directed to one of the said two transmission lines (a, (a-b)), and the other to the opposite end of the other line (d, (c-d)), so that the signals travel in the lines in opposite directions, and
the signals are summed (5) before the antenna elements (1-5).

2. A method according to claim 1, characterized in that the direction of the lobe created by the antenna elements (1, 2, 3, 4) is changed by feeding the transmission lines ((a-b), (c-d)) from their opposite ends (b, c), in which case the signals travel in a different direction in the transmission lines, but the mutual phase-differences remain essentially unchanged.

3. An apparatus for feeding signal power to an antenna array comprising several antenna elements (1-4), which apparatus includes
several antenna elements (1-4), and
two transmission lines (a-b) and (c-d) for feeding signal power to the antenna elements,
characterized by
the divisions (e) of one of the transmission lines (a-b) being shorter than the nominal wavelength and those (f) of the other (c-d) are longer than the nominal wavelength by the same amount,
means for dividing the signal s being fed into two parts, one of which is directed to one of the said two transmission lines (a, (a-b)) and the other is directed to the opposite end of the other line (d, (c-d)), so that the signals travel in the lines in opposite directions, and
summing elements (5), by means of which the signals coming from the different transmission lines can be summed before the antenna elements (1-5).
